(19) United States
(12) Patent Application Publication
(10) Pub. No.: US 2005/0024516 A1
(43) Pub. Date: Feb. 3, 2005

(54) Digital camera

(76) Inventors: Robert Fish, Gillette, NJ (US); Prabir Bhattacharya, Plainsboro, NJ (US)

Correspondence Address: HARNESS, DICKEY & PIERCE, P.L.C., P.O. BOX 828, BLOOMFIELD HILLS, MI, 48303, US

(21) Appl. No.: 10/631,368

(22) Filed: Jul. 31, 2003

(51) Int. Cl. H04N 5/222

(52) U.S. Cl. 348/333.03

(57) ABSTRACT

An improved digital camera is provided that detects pictures of human subjects whose eyes are not closed. The improved digital camera generally includes an eye detection activation element that is operable to initiate an eye detection mode; an image sensor that captures image data for a target subject; an image processor that converts the image data into a digital image form; and an eye detection component that evaluates the digital image form for the target subject and determines whether at least one eye of the target subject is closed.

### FIELD OF THE INVENTION

The present invention generally relates to photography and, more particularly, to digital cameras that are equipped to determine whether the eyes of a photographed person are open or closed.

### BACKGROUND OF THE INVENTION

Photographs of persons with their eyes closed are not desirable. However, amateur photographers often take quick snapshots of groups of humans (for example, family photographs). Since it is natural for humans to blink their eyes, one or more persons in a photograph may have their eyes closed. Therefore, it is desirable to provide an improved digital camera that alerts the camera operator when one of the persons in a photograph have their eyes closed or performs some other corrective action that enables the photographer to take better pictures. Conventional camera are not equipped to provides such features. It is further envisioned that this camera may be used for personal identification applications based on iris recognition technology.

### SUMMARY OF THE INVENTION

In accordance with the present invention, an improved digital camera is provided that detects pictures of human subjects whose eyes are not closed. The improved digital camera generally includes an eye detection activation element that is operable to initiate an eye detection mode; an image sensor that captures image data for a target subject; an image processor that converts the image data into a digital image form; and an eye detection component that evaluates the digital image form for the target subject and determines whether at least one eye of the target subject is closed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram depicting the principal components of an exemplary camera system designed according to the present invention;

FIG. 2 is a flow chart illustrating the operation of the exemplary camera system in accordance with the present invention; and

FIG. 3 is flow chart illustrating how face detection processing may be integrated into the operation of the exemplary camera system in accordance with the present invention; and

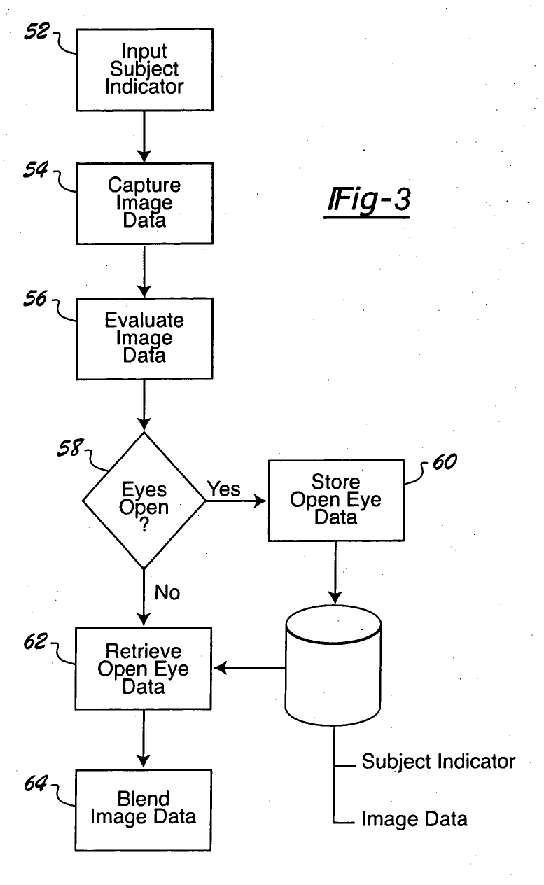

FIG. 4 is a flow chart illustrating an exemplary technique for digitally enhancing captured image data in accordance with the present invention.

### DETAILED DESCRIPTION OF THE PREFERRED EMBODIMENTS

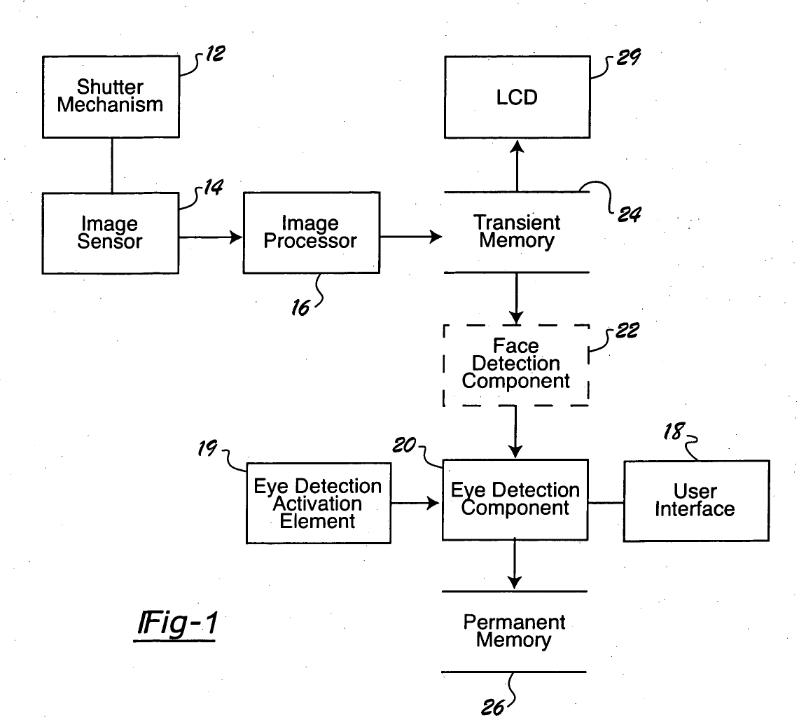

FIG. 1 illustrates the principal components of an exemplary digital camera system 10 in accordance with the present invention. The digital camera system 10 generally includes a shutter mechanism 12, an image sensor 14, an image processor 16, a data store, and a user interface 18. The digital camera system 10 further includes an eye detection activation element 19, an eye detection component 20, and, optionally, a face detection component 22. As will be further described below, the data store may be further defined to include a transient memory space 24 as well as a permanent memory space 26. It is readily understood that only the principle components are discussed herein, but that other known camera components may be incorporated into the camera system.

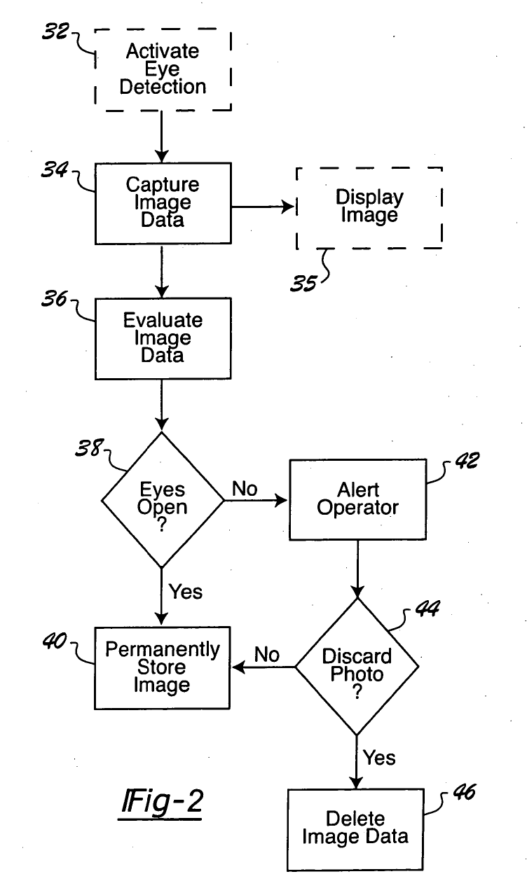

Operation of the digital camera system 10 is further described in relation to FIG. 2. To photograph a subject, the camera operator aims the camera at the target subject and actuates the shutter mechanism 12 via a push button or other user input element. It is readily understood that the camera operator may locate the subject using a viewfinder as well as adjust various known camera settings prior to taking the photograph. The shutter mechanism 12 in turn cooperatively operates with the image sensor 14 to capture image data including for a target subject as shown at step 34. In one exemplary embodiment, the image sensor 14 may be in the form of a charge coupled device. The image processor 16 is adapted to retrieve the captured image data from the image sensor. The image processor 16 then converts the image data into a digital image form and stores the digital image form in the transient memory space for additional processing by the camera 10.

In accordance with the present invention, the camera operator may activate an eye detection feature prior to taking the photograph as shown at step 32. For instance, when the camera operator ascertains that the target subject has eyes, the camera operator activates the eye detection feature using the eye detection activation element. Conversely, if the target subject does not include eyes, the camera operator may deactivate the eye detection feature using the eye detection activation element. It is envisioned that the eye detection activation element may take a variety of forms, including (but not limited to) push buttons, radial knobs, a touch screen display, or a combination thereof. Alternatively, digital camera system may be configured so that the eye detection feature is performed each time a photograph is taken.

In an eye detection mode, the eye detection component 20 is operable to evaluate the digital image form at step 36 to determine whether the eyes of any faces in the target subject are open or closed. The eye detection component 20 may employ one or more suitable algorithms to evaluate the digital image form. An exemplary eye detection algorithm is further described in an article by Saad A. Sirohey and Azriel Rosenfeld, entitled Eye Detection In A Face Image Using Linear and Non-Linear Filters, 36 PATTERN RECOGNITION 1387-1391 (2001). However, it is readily understood that other known eye detection algorithms are also within the broader scope of the present invention.

When the eyes of the target subject are deemed open, the eye detection component 20 moves the digital image form from the transient memory space to a permanent memory location as shown at step 40. In an alternative embodiment, the digital camera system may be employed in personal identification applications. To facilitate the identification process, the camera is preferably operable to perform iris recognition processing on the digital image form only when the eyes of the target subject are deemed open. Iris recognition may be implemented using one of a various well known algorithms.

On the other hand, when at least one eye of the target subject is deemed closed, the eye detection component 20 is further operable to perform at least one additional camera function based on this observation. In one embodiment, the eye detection component 20 cooperatively operates with the user interface to provide an alert to the camera operator as shown at step 42. It is readily understood that the alert may be audible, visual, or some other suitable form.

In addition to merely being alerted, the camera operator may be given the option to perform one or more corrective actions in relation to the recently taken photographs. For example, the camera operator may view the recently taken photograph using a display provided by the camera as shown at step 35. When viewing the photographs, the camera operator may determine if the photograph meets their needs, or if another photograph should be taken of the target subject. Furthermore, the camera operator may be given the option of deleting the corresponding digital image from the transient memory space (or to designate the digital image form for subsequent deletion). It is understood that the digital camera may be equipped with a view screen or other display device (e.g., an LCD display) for viewing the most recently taken photograph(s).

In one exemplary embodiment, the camera may be configured to support a single picture review mode and/or a multiple picture review mode. In a single picture review mode, the camera operator is prompted to individually review each photograph immediately after it has been taken. The camera operator is then given the option to retain or discard the photograph as shown at step 44. If the camera operator designates the photograph as being acceptable, then the corresponding digital image form is moved from its transient memory space to a permanent data store as shown at 40. Conversely, if the camera operator designates the photograph as being unacceptable, the corresponding digital image form is deleted from the transient memory space as shown at 46. In either case, it is understood that the camera provides suitable user input elements to ascertain the operators selection.

In a multiple picture review mode, the camera operator initially defers reviewing recently taken photographs. Thus, the camera operator may shoot a sequence of photographs. At the time the photographs are taken, the camera operator is provided an alert for each photograph that is deemed to have one or more closed eyes therein. At some later time, the camera operator is given the option to take some corrective action with respect to each of the deficient photographs. For instance, each recently captured photograph is individually displayed to the camera operator. Alternatively, only the defective photographs may be displayed to the camera operator. In either case, the camera operator is then given the option to retain or discard the displayed photograph. To facilitate review, the photographs may be sorted sequentially in time or, alternatively (at operators discretion), may be sorted according to the degree that the eyes are deemed to be closed. Once an option has been selected, the next photograph is displayed to the camera operator. In this way, the camera operator may select and save the preferred photographs from a series of photographs that may have been taken over a short period of time.

Alternatively, the camera may perform some corrective action without intervention by the camera operator. For instance, the camera may disregard photographs where the subject's eyes are deemed closed without prompting the operator. To decreasing processing time, each image in a sequence of images may not be evaluated by the eye detection component. If the subject is blinking, then a few milliseconds are generally needed to the subject's eyes to fully open. Therefore, when blinking is detected in an image, the camera may simple ignore the next few images in the sequence of images (e.g., 2-3 images depending on the speed of the camera). In other words, the camera does not apply the eye detection algorithm to this image data, thereby reducing processing time.

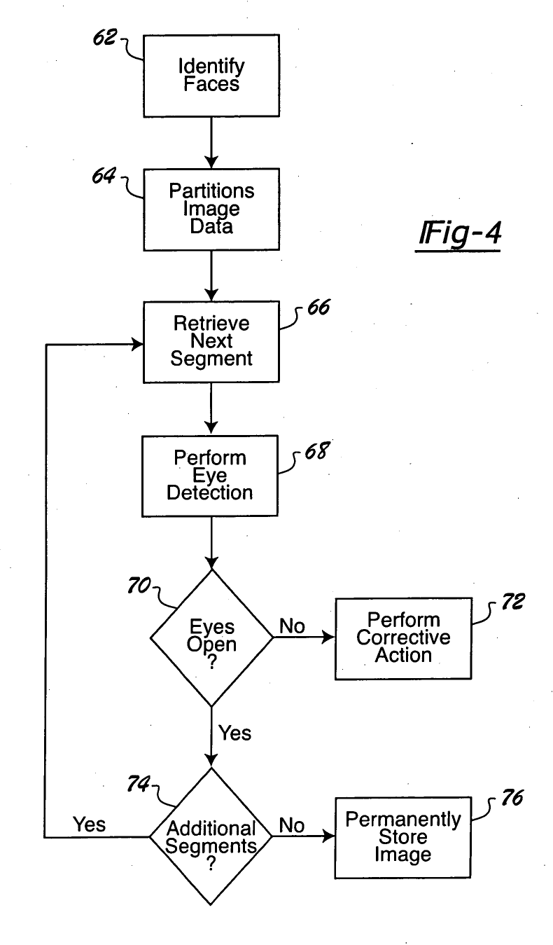

In another exemplary embodiment, the camera eliminates the subject's closed eyes from the photograph by digitally enhancing the captured image data as shown in FIG. 4. First, the camera operator provides or otherwise inputs at step 52 an indicator of the target subject into the camera. The camera operator then proceeds to capture at step 54 one or more images of the subject. The captured image data is evaluated at step 56 using an eye detection algorithm as further described above. When the eyes of the target are deemed open, the eye detection component is operable at step 60 to store an indicator of the subject along with corresponding image data in a database.

During the same sequence of captured images or at some subsequent time, the stored image data may be used to corrective deficient images as further described below. When the eyes of the target are deemed closed, the camera may apply a substitution process to digitally replace the closed eye image data with open eye image data taken from previously stored image data for the subject. To do so, the applicable image data is retrieved at step 62 from the database. Known blending techniques are then used at step 64 to incorporate portions of the image data having eyes of the subject into the most recently captured image data of the subject. In this way, the camera may enhance the captured image data.

In another aspect of the present invention, the digital camera system 10 may be further equipped with face detection component 22. The face detection component cooperatively operates with the eye detection component to evaluate the digital image form as shown in FIG. 4. Specifically, the face detection component identifies one or more faces associated with the target subject at step 72 and partitions the digital image form into partitioned data segments at step 74, such that each data segment includes at least a portion of a single face. To do so, the face detection component employs a suitable face detection algorithm such as the one set forth by Chellappa et al. in Human and Machine Recognition of Faces: A Survey, PROCEEDINGS OF THE IEEE, Vol. 83, No. 5 (May 1995). It is readily understood that other known face detection algorithms are within the scope of the present invention.

Each partitioned data segment then serves as an input to the eye detection component. For each partitioned data segment, eye detection processing is performed at step 78 as described above. When one eye in the face contained in the partitioned data segment is deemed closed, the camera proceeds with an additional camera function at step 82. When the eyes in the face contained in the partitioned data segment are deemed open, then the next partitioned data segment is retrieved for processing by the eye detection component as shown at step 76. Once all of the partitioned data segments have been analyzed (and it is determined that the eyes in each of the faces contained in the target subject are open), the eye detection component 20 will move the digital image form to a permanent memory location as shown at step 86.

The description of the invention is merely exemplary in nature and, thus, variations that do not depart from the gist of the invention are intended to be within the scope of the invention. Such variations are not to be regarded as a departure from the spirit and scope of the invention.

1. A camera, comprising:
an eye detection activation element operable by a camera operator to initiate an eye detection mode;
an image sensor that is operable to capture image data for a target subject;
an image processor adapted to retrieve said image data from said image sensor and operable to convert said image data into a digital image form; and
an eye detection component being operable to evaluate said digital image form for said target subject in said eye detection mode and determine whether at least one eye of said target subject is closed.

2. The camera of claim 1 wherein the eye detection component is further operable to at least one of provide an alert to an operator of said camera or delete said digital image form from said transient memory space when at least one eye of said target subject is closed.

3. The camera of claim 1 further comprises a data store having a transient memory space, said digital image form stored in said transient memory space by said image processor for evaluation by said eye detection module.

4. The camera of claim 3 wherein said eye detection module is further operable to delete said digital image form from said transient memory space when at least one eye of said target subject is closed.

5. The camera of claim 1 further comprises a data store having a permanent memory space, said eye detection component being operable to move said digital image form to said permanent memory space when eyes of said target subject are open.

6. The camera of claim 1 further comprises a view screen that is operable to display an image of the target subject based on the digital image form.

7. The camera of claim 1 wherein said eye detection component is operable to present the camera operator with an option to discard the digital image form for the target subject when at least one eye of said target subject is closed and to delete the digital image form from said transient memory space in response to an input delete command received from the camera operator.

8. The camera of claim 1 further comprises a face detection component that is operable to identify one or more faces in said target subject and partition the digital image form into a plurality of data segments, such that each data segment includes at least a portion of a face, said eye detection component being further operable to evaluate each data segment of the plurality of data segments.

9. A camera, comprising:
an image sensor that is operable to capture image data for a target subject having at least one eye;
a data store having a transient memory space;
an image processor adapted to retrieve said image data from said image sensor, said image processor being operable to convert said image data into a digital image form and to store said digital image form in said transient memory space of said data store; and
an eye detection component operable to evaluate said digital image form residing in said transient memory space and determine whether an eye of said target subject is closed, said eye detection component further operable to at least one of provide an alert to an operator of said camera or delete said digital image form from said transient memory space when at least one eye of said target subject is closed.

10. The camera of claim 9 wherein said data store further includes a permanent memory space, said eye detection component being operable to move said digital image form from said transient memory space to said permanent memory space when the eyes of said target subject are open.

11. The camera of claim 9 further comprises a view screen that is operable to display an image of the target subject based on the digital image form.

12. The camera of claim 9 further comprises a face detection component that is operable to identify one or more faces in said target subject and partition the digital image form into a plurality of data segments, such that each data segment includes at least a portion of a face, said eye detection component being further operable to evaluate each data segment of the plurality of data segments.

13. A method for taking pictures using a digital camera comprising:
capturing image data for a target subject having at least one eye;
evaluating said image data to determine whether said at least one eye is open or closed; and
performing at least one camera operation based upon whether the eyes of the target subject are open or closed.

14. The method of claim 13 wherein the step of capturing image data further comprises activating a shutter mechanism of the camera by a camera operator.

15. The method of claim 13 wherein the step of capturing image data further comprises:
collecting said image data using a image sensor;
converting said image data into a digital image form using said image processor; and
storing said digital image form in a transient memory space accessible to the image processor.

16. The method of claim 13 wherein the step of evaluating said image data further comprises:
detecting one or more faces in said image data:
partitioning said image data into a plurality of data segments, such that each data segment includes a portion of one face;
evaluating each of the data segments to determine whether at least one eye of the target subject is closed.

17. The method of claim 13 wherein the step of performing at least one camera operation further comprises transferring said image data to a permanent memory space when the eyes of the target subject are open.

18. The method of claim 13 wherein the step of performing at least one camera operation further comprises displaying the image data to the camera operator for review.

19. The method of claim 13 wherein the step of performing at least one camera operation further comprises providing an alert to the camera operator when at least one of the eyes of the target subject are closed.

20. The method of claim 15 wherein the step of performing at least one camera operation further comprises deleting said image data from the transient memory space when at least one of the eyes of the target subject are closed.

21. The method of claim 13 wherein the step of performing at least one camera operation further comprises performing iris recognition when the eyes of the target subject are open.
